(19) United States
(12) Patent Application Publication
(10) Pub. No.: US 2016/0364335 A1
(43) Pub. Date: Dec. 15, 2016

(54) CLEAR ROUTE CACHE COMMANDS FOR NETWORK COMMUNICATIONS PLATFORMS

(71) Applicants: Mark V. Deisinger, Roseville, MN (US); Allyn D. Smith, Roseville, MN (US)

(72) Inventors: Mark V. Deisinger, Roseville, MN (US); Allyn D. Smith, Roseville, MN (US)

(73) Assignee: Unisys Corporation, Blue Bell, PA (US)

(21) Appl. No.: 14/737,774

(22) Filed: Jun. 12, 2015

(51) Int. Cl. G06F 12/08

(52) U.S. Cl. CPC G06F 12/0833; G06F 12/0813; G06F 2212/621; G06F 2212/314

(57) ABSTRACT

Route table cache clear commands may be performed using a communications platform that communicates with a web service and/or terminal emulator. The communications platform may implement a command that clears the route tables for an IPv4 network or link. The communications platform may also implement a general command that clears the route tables for all IPv4 and IPv6 networks or links, or any subsets thereof. These commands may give an administrator greater flexibility in managing the impact of network or configuration changes on the behavior of the communications platform. When network changes occur, the administrator may use these commands to invoke re-discovery of network paths, potentially avoiding connection interruptions.

The instant disclosure relates to providing clear route cache commands for network communications platforms. More specifically, this disclosure relates to clear route commands that can clear out IPv4 routing tables (RTs).

### BACKGROUND

A communications platform, such as Unisys CPComm, is a high-speed communications product that may connect application programs on a network server with terminals, workstations, and other applications in a data communications network. A communications platform software package may provide many key attributes, including, for example, high reliability, high throughput, low latency, security, support of open communications standards, and ease of administration. Applications on the network server may use the communications platform to connect to various types of networks, such as Ethernet and FDDI networks. The network may contain various hardware and software products that conform to open systems standards. The communications platform may implement TCP/IP protocols.

Internally, the communications platform may have a set of data structures called route tables (RTs) that, individually, describe routes between local addresses and destination addresses. The communications platform may maintain two types of RT caches: one for use with Internet Protocol Version 4 (IPv4) addresses and one for Internet Protocol Version 6 (IPv6) addresses. Over time, the communications platform may build RTs as needed based on events that occur, such as sending and receiving IP packets. The communications platform may also have mechanisms for periodically checking and deleting inactive RTs and for removing RTs that are invalidated by dynamic configuration changes.

Some network reconfiguration operations external to the communications platform may invalidate RTs even though there has not been a dynamic reconfiguration of the communications platform itself. In these cases, a timeout period may be used to ensure that current RTs are not accidentally deleted. For this reason, the timeout period for inactive RTs may be quite lengthy. In some cases, a periodic timer for checking and removing inactive RTs may fire off every 5 minutes. Additionally, a threshold for determining if a specific RT is inactive may be 10 minutes. Therefore, an RT may be idle for up to 15 minutes before it is considered inactive and removed. While these invalid RTs remain in play, the communications platform may be unable to establish new RTs that would replace the existing but defunct RTs. This may hinder network traffic and slow connection speeds.

To prevent this situation, it may be helpful for an operator to manually clear out RTs that he knows to be invalid. In some communications platforms, a clear route cache command may exist for IPv6. The clear route cache command may allow the operator to clear the RT cache for all of IPv6 or all of the RTs that correspond to a specific IPV6 network. However, there is no similar capability for IPv4 in some platforms. There is a need for one or more clear route cache commands to provide for manual clearing of the IPv4 RT cache.

### SUMMARY

An IPv4 CLEAR command may clear the contents of the communications platform route table cache for all IPv4 links or for a specific IPv4 link. Clearing the route table cache for an IPv4 link may force the communications platform to rediscover routes for the affected IPv4 destinations.

A general CLEAR command may clear the contents of the communications platform route table cache for all IPv4 links and IPv6 networks, or for a subset. Clearing the route table cache for an IPv6 network may force the communications platform to perform a next hop determination for affected IPv6 destinations.

According to one embodiment, a method of clearing route table caches includes receiving, by a server comprising at least one processor, a command from an operator, determining that the command is a clear cache command, determining a subtype of the clear cache command; setting up a clear cache execution event; and executing the clear cache execution event, where the subtype is directed to one or more IPv4 route table caches. In some embodiments, the subtype is directed to a specific IPv4 network, a specific IPv4 link, or a general cache clear command.

In some embodiments, the method of executing the clear cache execution event further includes cycling through a list of entries in the one or more IPv4 route table caches; determining that one or more entries match a criteria of the clear cache command; clearing the one or more entries; determining that the clear cache execution event has ended; and issuing a display message informing the operator that the route table caches have been cleared.

In some embodiments, the method further includes cycling sequentially through all of the one or more IPv4 route table caches when the subtype is a general cache clear command; and clearing all of the one or more entries. In some embodiments, the method further includes cycling sequentially through one or more IPv6 route table caches after the one or more IPv4 route table caches have been cleared; and clearing all entries of the one or more IPv6 route table caches.

According to another embodiment, a computer program product includes a non-transitory computer readable medium having code to receive a command from an operator, code to determine that the command is a clear cache command; code to determine a subtype of the clear cache command; code to set up a clear cache execution event; and code to execute the clear cache execution event, where the subtype is directed to one or more IPv4 route table caches.

In some embodiments, the medium further includes code to cycle through a list of entries in the one or more IPv4 route table caches; code to determine that one or more entries match a criteria of the clear cache command; code to clear the one or more entries; code to determine that the clear cache execution event has ended; and code to issue a display message informing the operator that the route table caches have been cleared.

In some embodiments, the medium further includes code to cycle sequentially through all of the one or more IPv4 route table caches when the subtype is a general cache clear command; and code to clear all of the one or more entries. In some embodiments, the medium further includes code to cycle sequentially through one or more IPv6 route table caches after the one or more IPv4 route table caches have been cleared; and code to clear all entries of the one or more IPv6 route table caches.

According to a further embodiment, an apparatus includes a memory for storing a database and includes a processor coupled to the memory. The processor is configured to receive a command from an operator; to determine that the command is a clear cache command; to determine a subtype of the clear cache command; to set up a clear cache execution event; and to execute the clear cache execution event, where the subtype is directed to one or more IPv4 route table caches.

In some embodiments, the processor is further configured, when executing the clear cache execution event, to cycle through a list of entries in the one or more IPv4 route table caches; to determine that one or more entries match a criteria of the clear cache command; to clear the one or more entries; to determine that the clear cache execution event has ended; and to issue a display message informing the operator that the route table caches have been cleared.

In some embodiments, the processor is further configured to cycle sequentially through all of the one or more IPv4 route table caches when the subtype is a general cache clear command; and to clear all of the one or more entries. In some embodiments, the processor is further configured to cycle sequentially through one or more IPv6 route table caches after the one or more IPv4 route table caches have been cleared; and to clear all entries of the one or more IPv6 route table caches.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating an exemplary method for executing an IPv4 clear RT cache command in a communications platform.

FIG. 2 is a flow chart illustrating an exemplary method for executing a general clear RT cache command in a communications platform.

FIG. 3 is a diagram illustrating one embodiment of a system for implementing IPv4 clear RT cache commands.

FIG. 4A is a block diagram illustrating a server hosting an emulated software environment for virtualization according to one embodiment of the disclosure.

FIG. 4B is a block diagram illustrating a server hosting an emulated hardware environment according to one embodiment of the disclosure.

### DETAILED DESCRIPTION

For maximum usefulness and consistency, an IPv4-specific manual RT cache clearing command may be provided. The IPv4 command may be consistent with a definition of an existing IPv6-specific command. A generalized command that can be used for both IPv4 and IPv6 or for any subset of the whole may also be provided. This command may be consistent with existing commands to clear an Address Resolution Protocol (ARP) cache or a Domain Name Resolver (DNR) cache.

An IPv6 clear cache command may clear the contents of a communications platform neighbor table cache or a RT cache. Clearing the neighbor table cache may enable the communications platform to use IPv6 neighbor discovery protocol to discover or rediscover neighbor devices. Clearing the RT cache may enable the communications platform to perform a next hop determination before communicating with an IPv6 destination. In some embodiments, the IPv6 clear cache command may be used to clear all entries in the RT cache. In other embodiments, the IPv6 clear cache command may be used to clear only RT entries for devices on a specified IPv6 network.

A first command (IPv4 clear cache command) may be an IPv4-only equivalent of the IPv6 clear cache command. This command may clear the entire IPv4 RT cache or the RTs that correspond to a specific IPv4 link statement. The second command may combine the IPv6 clear cache command and the IPv4 clear cache command while also allowing for the clearing of cache subsets. Both new commands may take some advantage of existing functionality within the communications platform for clearing out RTs.

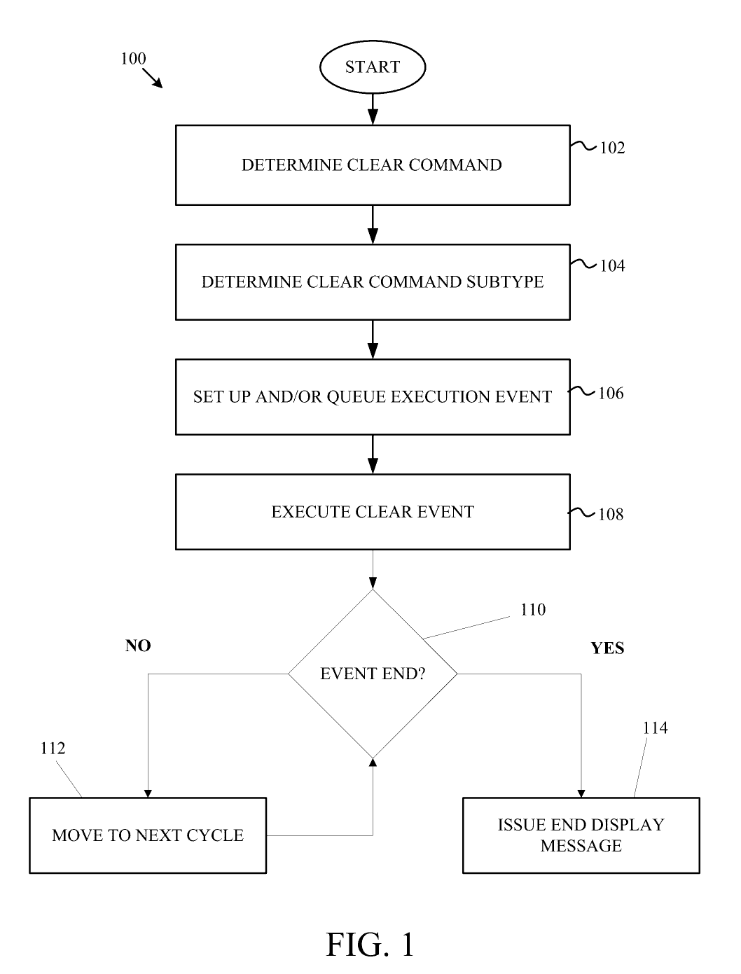

FIG. 1 is a flow chart illustrating an exemplary method for executing an IPv4 clear RT cache command in a communications platform. A method 100 begins at block 102 when a local server may determine whether a received command is a CLEAR command. In some embodiments, there may be different types of CLEAR commands. For example, the CLEAR command may be an ARP cache CLEAR command, a DNR cache CLEAR command, an IPv4 CLEAR command, or an IPv6 CLEAR command.

At block 104, if the local server determines that the command is a CLEAR command, the local server may determine a subtype of the CLEAR command. In some embodiments, the CLEAR command may be directed to all networks accessed by the local server or a subset of networks. For example, the subtype of a CLEAR command may be directed to a specific IPv4 or IPv6 link, a specific IPv4 or IPv6 network, or all IPv4 or IPv6 networks.

At block 106, the local server may set up to execute the cache CLEAR command on the one or more appropriate destination caches. In some embodiments, the local server may determine a type of table cache to clear. The CLEAR command may be directed to a neighbor table cache and/or a routing table cache. The local server may also determine whether the CLEAR command applies to the entire cache or a subset of cache entries. This may be determined by the detected subset type of the CLEAR command. The subset of cache entries may be directed to a specific network or link.

The local server may determine a list of main and non-main lower layer activities running between one or more destination servers. The main lower layer activity may maintain route table entries for loopback resolutions only in both IPv4 and IPv6. These loopback route tables may never change and may never need to be cleared while the communications platform is running. For this reason, the local server may bypass queuing a CLEAR event to the main lower layer activity.

In a case where the entire cache is to be cleared, the local server may queue the CLEAR event to the first non-main lower level activity on the lower level activity list for all destination network servers. In a case where a specific network or link is to be cleared, the local server may determine a destination server for that network. Once the proper destination server for the network has been determined, the local server may queue the CLEAR event to the first non-main lower level activity that owns the local RT cache which describes connections to that remote destination server. Once the event is de-queued, the local server may execute the CLEAR event.

At block 108, the local server executes the CLEAR event. The local server may cycle through a list of all route table cache data structures of a specific destination server. If a specific route table cache entry matches a criteria of the CLEAR command, the route table cache entry may be deleted and cleaned up. The local server may move through all the route table cache entries in the list.

At decision 110, when the local server reaches the end of the list of entries, the local server must determine whether the CLEAR event has ended. This may depend on whether the CLEAR command was directed to the entire cache or to a specific network or link. If the CLEAR command was directed to the entire cache, at block 112, the local server may move to the next destination server and begin to cycle through that server's list of route table entries. Once this cycle has ended, the process may return to decision 110 where the local server may determine whether the CLEAR event has ended. Alternatively, if the CLEAR command was directed to the specific network corresponding to the destination server or if the general clearing process of block 112 has finished, the local server, at block 114, may issue a display message indicating that the route table processing has been completed and quit the process.

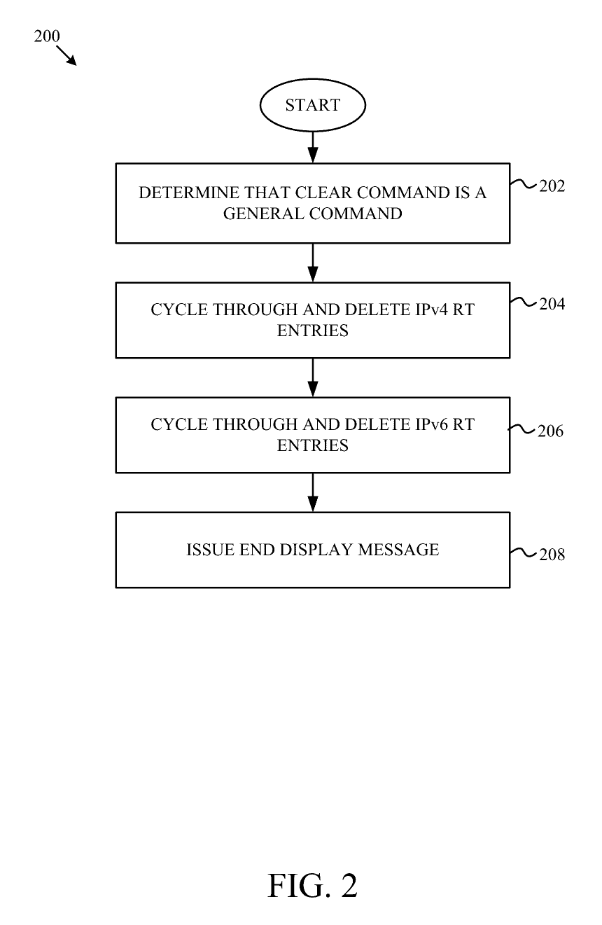

FIG. 2 is flow chart illustrating an exemplary method for executing a general clear RT cache command in a communications platform. A method 200 begins at block 202 when the local server may determine that the CLEAR command is a general CLEAR command directed to all IPv4 and IPv6 networks. At block 204, the CLEAR event may cycle through a lower level activity list for all destination network servers and delete all IPv4 route table cache entries. At block 206, the CLEAR event may recycle through the lower level activity list for all destination network servers and delete all IPv6 route table cache entries. At block 208, when the local server reaches the end of the IPv6 cycle, the local server may issue a display message indicating an end of route table processing and quit the process.

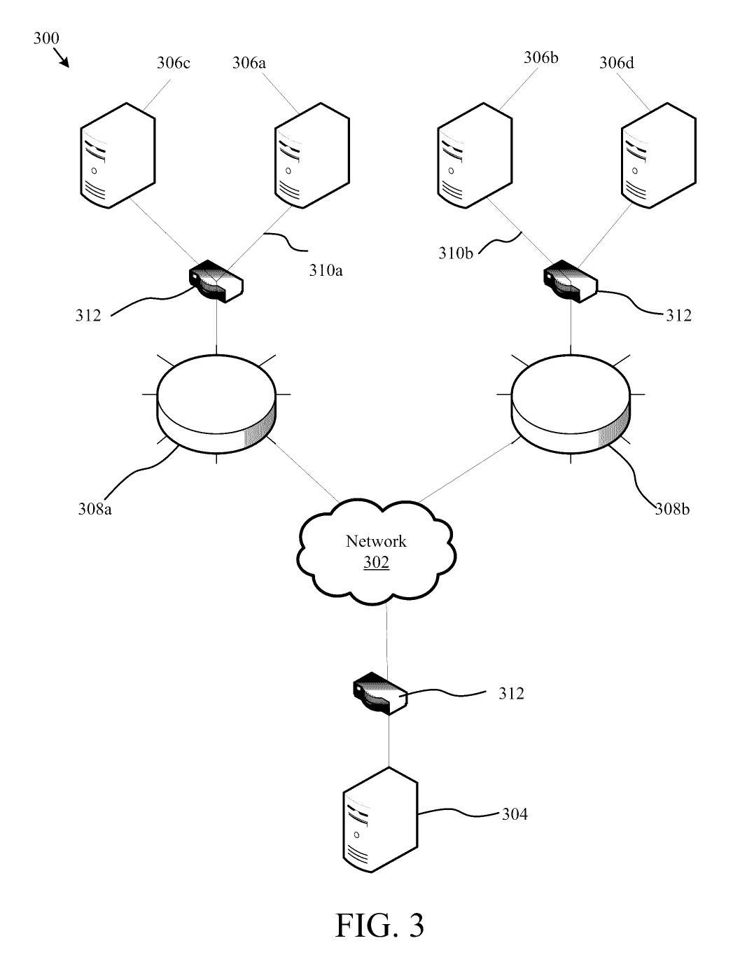

FIG. 3 illustrates one embodiment of a system 300 for implementing IPv4 CLEAR cache commands. The system 300 may include a global network 302, a local server 304, and one or more destination servers 306. In one embodiment, global network 302 may comprise one or more local networks 308. In a further embodiment, one or more local networks 308a, 308b may connect one or more destination servers 306 to global network 302. In a further embodiment, destination servers 306 may connect to a particular local network 308a, 308b via network links 310a, 310b. In certain embodiments, destination servers 306 may have IPv4 addresses or IPv6 addresses and local area networks 308a, 308b may be IPv4 or IPv6 networks. For example, local area network 308a may be an IPv4 network and local area network 308b may be an IPv6 network. In a further embodiment, the local server 304 and destination servers 306 may comprise network interface cards and be connected to global network 302 by one or more routers 312. Other nonlimiting and suitable means for connecting servers to networks may be used.

Local server 304 may receive a CLEAR command from an operator and may begin method 100 or method 200. As discussed above, the CLEAR command may be an IPv4, IPv6, or general CLEAR command. If local server 304 determines that the CLEAR command is directed to a specific local area network 308, local server 304 may implement method 100 to queue and execute CLEAR events for each of the one or more destination servers 306 connected to the specific local network 308. For example, if the CLEAR command is directed to IPv4 local area network 308a, CLEAR events may be executed on the caches corresponding to IPv4 destination servers 306a and 306c. If local server 304 determines that the CLEAR command is directed to a specific network link 310, local server 304 may implement method 100 to queue and execute CLEAR events for the specific destination server 306 connected to the specific link 310 in the specific local network 308. For example, if the CLEAR command is directed to IPv4 network link 310a, a CLEAR event may be executed on the cache corresponding to IPv4 destination server 306a. If local server 304 determines that the CLEAR command is a general CLEAR command, local server 304 may implement method 200 to queue and execute CLEAR events for both IPv4 local area network 308a and IPv6 local area network 308b. As discussed previously, the IPv4 networks may be cleared before the IPv6 networks. For example, the IPv4 destination servers 306a, 306c may be sequentially cleared first, followed by sequentially clearing the IPv6 destination servers 306b, 306d.

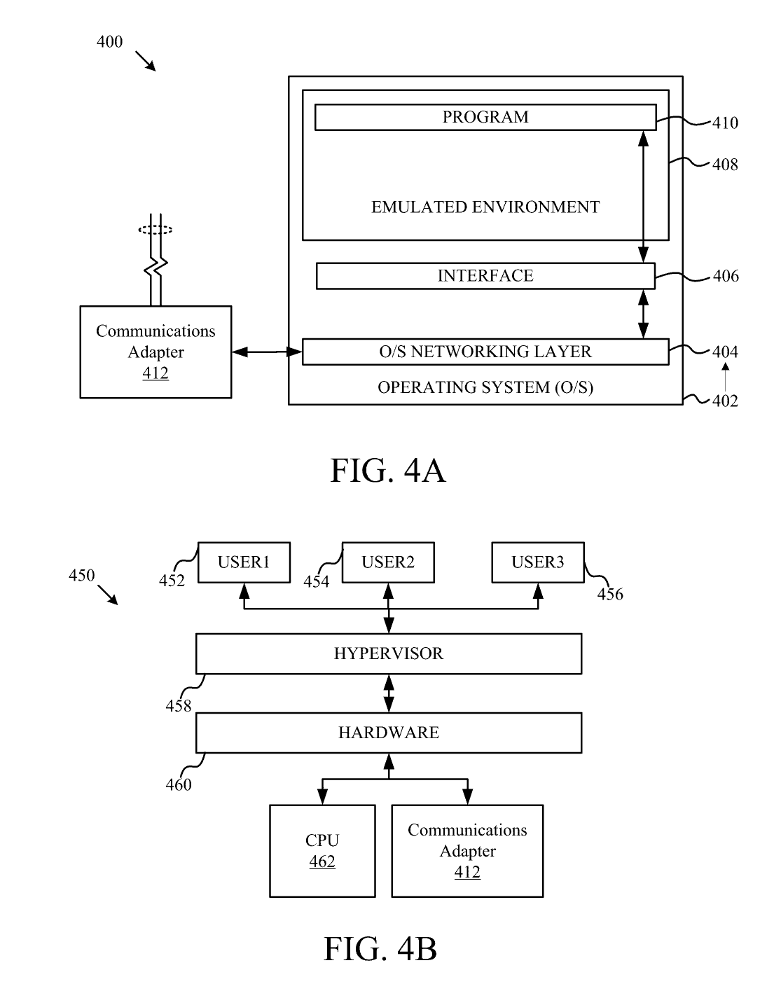

FIG. 4A is a block diagram illustrating a server 400 hosting an emulated software environment for virtualization according to one embodiment of the disclosure. In some embodiments, local server 304 and/or destination servers 306 may have the structure as server 400. An operating system 402 executing on server 400 may include drivers for accessing hardware components, such as a networking layer 404 for accessing a communications adapter 412. The operating system 402 may be, for example, Linux. An emulated environment 408 in the operating system 402 may execute a program 410, such as CPCommOS or other communications platform. The program 410 may access the networking layer 404 of the operating system 402 through a non-emulated interface 406, such as XNIOP. The non-emulated interface 406 may translate requests from the program 410 executing in the emulated environment 408 for the networking layer 404 of the operating system 402.

In another example, hardware in a computer system may be virtualized through a hypervisor. FIG. 4B is a block diagram illustrating a server 450 hosting an emulated hardware environment according to one embodiment of the disclosure. Users 452, 454, 456 may access the hardware 460 through a hypervisor 458. The hypervisor 458 may be integrated with the hardware 460 to provide virtualization of the hardware 460 without an operating system, such as in the configuration illustrated in FIG. 4A. The hypervisor 458 may provide access to the hardware 460, including the CPU 462 and the communications adaptor 412.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of clearing route table caches, comprising:
receiving, by a server comprising at least one processor, a command from an operator;
determining that the command is a clear cache command;
determining a subtype of the clear cache command;
setting up a clear cache execution event; and
executing the clear cache execution event, where the subtype is directed to one or more IPv4 route table caches.

2. The method of claim 1, where the subtype is directed to a specific IPv4 network.

3. The method of claim 1, where the subtype is directed to a specific IPv4 link.

4. The method of claim 1, where the subtype is directed to a general cache clear command.

5. The method of claim 1, the executing the clear cache execution event comprising:
cycling through a list of entries in the one or more IPv4 route table caches;
determining that one or more entries match a criteria of the clear cache command;
clearing the one or more entries;
determining that the clear cache execution event has ended; and
issuing a display message informing the operator that the route table caches have been cleared.

6. The method of claim 5, further comprising:
cycling sequentially through all of the one or more IPv4 route table caches when the subtype is a general cache clear command; and
clearing all of the one or more entries.

7. The method of claim 6, further comprising:
cycling sequentially through one or more IPv6 route table caches after the one or more IPv4 route table caches have been cleared; and
clearing all entries of the one or more IPv6 route table caches.

8. A computer program product, comprising:
a non-transitory computer readable medium comprising:
code to receive a command from an operator;
code to determine that the command is a clear cache command;
code to determine a subtype of the clear cache command;
code to set up a clear cache execution event; and
code to execute the clear cache execution event, where the subtype is directed to one or more IPv4 route table caches.

9. The computer program product of claim 8, where the subtype is directed to a specific IPv4 network.

10. The computer program product of claim 8, where the subtype is directed to a specific IPv4 link.

11. The computer program product of claim 8, where the subtype is directed to a general cache clear command.

12. The computer program product of claim 8, where the code to execute the clear cache execution event further comprises:
code to cycle through a list of entries in the one or more IPv4 route table caches;
code to determine that one or more entries match a criteria of the clear cache command;
code to clear the one or more entries;
code to determine that the clear cache execution event has ended; and
code to issue a display message informing the operator that the route table caches have been cleared.

13. The computer program product of claim 12, further comprising:
code to cycle sequentially through all of the one or more IPv4 route table caches when the subtype is a general cache clear command; and
code to clear all of the one or more entries.

14. The computer program product of claim 13, further comprising:
code to cycle sequentially through one or more IPv6 route table caches after the one or more IPv4 route table caches have been cleared; and
code to clear all entries of the one or more IPv6 route table caches.

15. An apparatus, comprising:
a memory for storing a database; and
a processor coupled to the memory, in which the processor is configured:
to receive a command from an operator;
to determine that the command is a clear cache command;
to determine a subtype of the clear cache command;
to set up a clear cache execution event; and
to execute the clear cache execution event, where the subtype is directed to one or more IPv4 route table caches.

16. The apparatus of claim 15, where the subtype is directed to a specific IPv4 network.

17. The apparatus of claim 15, where the subtype is directed to a specific IPv4 link.

18. The apparatus of claim 15, where the subtype is directed to a general cache clear command.

19. The apparatus of claim 15, where, when executing the clear cache execution event, the processor is further configured:
to cycle through a list of entries in the one or more IPv4 route table caches;
to determine that one or more entries match a criteria of the clear cache command;
to clear the one or more entries;
to determine that the clear cache execution event has ended; and
to issue a display message informing the operator that the route table caches have been cleared.

20. The apparatus of claim 19, where the processor is further configured:
to cycle sequentially through all of the one or more IPv4 route table caches when the subtype is a general cache clear command; and
to clear all of the one or more entries.

21. The apparatus of claim 20, where the processor is further configured:
to cycle sequentially through one or more IPv6 route table caches after the one or more IPv4 route table caches have been cleared; and
to clear all entries of the one or more IPv6 route table caches.
